(19) United States
(12) Patent Application Publication
(10) Pub. No.: US 2016/0283984 A1
(43) Pub. Date: Sep. 29, 2016

(54) CHAT ADVERTISEMENTS

(71) Applicant: TangoMe, Inc., Mountain View, CA (US)

(72) Inventors: Richard RABBAT, Palo Alto, CA (US); Jennifer Ann DONAHOE, Manhattan Beach, CA (US); Xu LIU, San Jose, CA (US)

(21) Appl. No.: 14/670,243

(22) Filed: Mar. 26, 2015

(51) Int. Cl. G06Q 30/02; G06F 3/0485; G06F 3/0484; G06F 3/0482; H04L 12/58; G06Q 50/00

(52) U.S. Cl. CPC G06Q 30/0269; H04L 51/10; H04L 51/32; H04L 51/046; G06Q 50/01; G06F 3/04842; G06F 3/0482; G06F 3/0485

(57) ABSTRACT

A method for presenting an advertisement within a display of information provided by a messaging application is described. The method includes: providing, at a display, a selectable advertisement as part of a messaging application, wherein the selectable advertisement is implemented in a native code of the messaging application; receiving a selection of the selectable advertisement to achieve a selected advertisement, wherein the selection initiates an execution of a set of instructions regarding a presentation of information associated with the selected advertisement; presenting the information according to the set of instructions.

### REFERENCE TO RELATED APPLICATIONS

This application claims the benefit of co-pending U.S. Patent Application No. 61/981,616 filed on Apr. 18, 2014 entitled “CHAT ADVERTISEMENTS” by Liu et al., having Attorney Docket No. TNGO-033.PRO, and assigned to the assignee of the present application, and is hereby incorporated by reference in its entirety herein.

### BACKGROUND

Conventional technologies and methods for providing advertisements (“ads”) in web-based applications generally distract the user and impact the user's experience in a negative way.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 illustrates an example of a response, including all information to fully display an ad, in accordance with an embodiment.

FIG. 2 illustrates an example of an ad impression in a social feed, in accordance with an embodiment.

FIG. 3 illustrates an example of an ad impression is a profile view, in accordance with an embodiment.

FIG. 4 illustrates an example of an ad impression in a chat list, in accordance with an embodiment.

FIG. 5 illustrates an example of an ad impression in a chat messaging list, in accordance with an embodiment.

FIG. 6 is a block diagram that illustrates an embodiment of an advertisement presenter, in accordance with an embodiment.

FIG. 7 depicts a flow diagram for a method for presenting an advertisement within a display of information provided by a messaging application, in accordance with an embodiment.

FIG. 8 is a block diagram of an example computer system with which or upon which various embodiments of the present invention may be implemented.

### DESCRIPTION OF EMBODIMENTS

Reference will now be made in detail to various embodiments, examples of which are illustrated in the accompanying drawings. While various embodiments are discussed herein, it will be understood that they are not intended to be limiting. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding. However, embodiments may be practiced without one or more of these specific details. In other instances, well known methods, procedures, components, and circuits have not been described in detail as not to unnecessarily obscure aspects of the described embodiments.

### Notation and Nomenclature

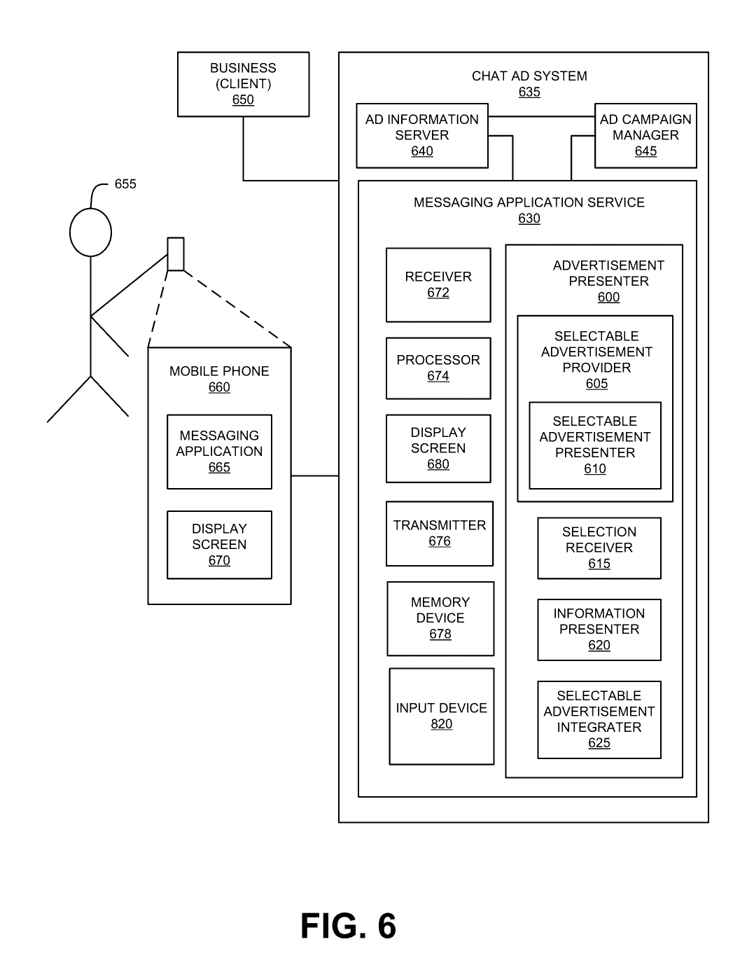

Unless specifically stated otherwise as apparent from the following discussions, it is appreciated that throughout the present Description of Embodiments, discussions utilizing terms such as “providing,” “receiving”, “presenting”, “installing”, “displaying”, “integrating”, or the like, often refer to the actions and processes of an electronic computing device (or portion thereof), module or system, such as, but not limited to, an advertisement present 600 (See FIG. 6), unless noted otherwise. The electronic computing device/module/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Overview of Embodiments and Discussion

Conventional technologies and methods for providing advertisements (“ads”) in web-based applications generally distract the user and impact the user's experience in a negative way. Conventional technologies do not have a method for monetizing chat applications and/or do not provide ads in web-based applications, wherein the ads are integrated within the web-based applications as part of the user's experience without the disadvantages outlined above.

Embodiments of the present technology provide a monetization solution, via a chat advertising (“ad”) system, for messaging applications that delivers revenue and does not impact the user's experience. More specifically, embodiments enable chat ads to be used in a messaging application to: 1) drive and promote application installations and application sales-not only may chat ads be used to achieve a direct sale of an application (e.g., a gaming application), but chat ads may be used to cross-promote applications for partner games to a particular application; and 2) drive and promote engagements between a client (a user using the messaging application) of a service (providing the messaging application) and advertisers (advertising on the messaging application).

In accordance with embodiments, the chat ads will be displayed as part of an application's native platform. Chat ads, according to embodiments, are displayed in at least one of the following three locations of a messaging application (e.g., Tango™): a social feed; a chat list; and a profile page.

According to embodiment, chat ads may be displayed in a user's (of the messaging application) social feed and/or the chat list to drive re-engagement between the messaging application's client (user) and the application being advertised, as well as to promote the installation of the application being advertised. Standard banner ads may also be used in the social feed and/or chat list of the messaging application's client.

According to embodiments, chat ads may be displayed in the profile page to promote (to the messaging application's client [user of the messaging application])) the installation of the application being advertised. Standard banner ads may also be used in the profile page of the messaging application's client.

Embodiments provide methods and systems that enable ads to be displayed as part of a social feed, chat list, or profile of a messaging application. For example, in one embodiment, a new ad unit to be included in a chat list is integrated into the chat list in such a way that blends with other already existing chat ad units within the chat list. This method and system improves the user experience for users as the new ad unit behaves like the already existing chat ad units and the users can engage with the new ad unit in a similar way as they engage with the already existing chat ad units.

For example, a user is able navigate in the chat list by sliding the chat list upward and downward. The new ad unit respects these navigation instructions (accomplished by a user swiping up and/or down) and moves in unison with the already existing chat ad units.

In another example, the user is able to delete an already existing chat ad unit. For example, on an iPhone™, a user can swipe the screen from left to right or from right to left to make the already existing chat ad unit disappear. On an Android™, a long press on the already existing chat ad unit will pull up a menu item, at which the user is given the option to hide or delete the already existing chat ad unit. Embodiments also provide the user with the ability to report the already existing chad ad unit (in one example), to the business operating the messaging application and to the advertiser advertising via the already existing chat ad unit. A user that reports the already existing chat ad can include in the details of this report the reason for reporting, including, but not limited to the following reasons: offensive content; sexual content; violent content; abuse content; spam; repetitive content; the user already has the application being advertised, etc.

Embodiments of the chat ad system also enable ads to be created on demand, as will be described herein.

In sum, embodiments of the chat ad system provide at least the following advantages: 1) The chat ads look seamless and improve the user's experience as the customer is part of a customer base (for example, the Tango™ customer base); 2) The ad has improved technical performance because it relies on native code for its implementation. For example, the application's technical performance is much better for regular chat ads, which use a web view for its display; and 3) The chat ad has a more accurate and useful business metric performance than regular ads because: a) an impression is considered to be made and then measured when the ad is displayed as well as viewed by the customer (user); and b) the native ad unit reduces accidental clicks that happen with regular chat ads.

The following is a discussion of the operation of the chat ad system, including: 1) the management of chat ads; 2) the process of requesting a chat ad for display; 3) the response given to the request for a chat ad; 4) monitoring chat ad impressions in the social feed of a customer, in the profile view of a customer, and in the chat list of a customer; and 5) the aggregation of advertising campaign information.

### Managing Chat Ads

In embodiments, the chat ads that are available at the messaging application are managed by a campaign management tool, operated by a human (e.g., ad operations person, etc.) at the messaging application service. The messaging application service is an entity that controls all aspects of the messaging application, and supports the functionalities of the messaging application.

The campaign management tool is able to perform any of the following functions: set start; pause; end; archive date to the campaign; set geo location for where the campaign shall run; potentially target age and gender when available; set impression limits (lifetime of the ad, frequency at which an ad can be displayed to a user, etc.); stop trafficking ads for a campaign in under an hour; run multiple campaigns at the same time, targeted at different or the same users; and see and monitor the revenue, requests, impressions, clicks, CTR (clickthrough rate), cony, fill rate, and eCPM (effective cost per mille) by campaign, and date.

In one embodiment, the campaign management tool provides the ability to monitor a campaign in progress with a maximum delay of 12 hours. The campaign management tool does not require root access to messaging application servers, in one embodiment.

### Chat Ad Requests

In one embodiment, the messaging application requests a chat ad from the ad information server. In one embodiment, the chat ad may be fetched from the client (organization that is providing or causing to be provided, a chat ad to be placed in the messaging application according to embodiment) or from the ad server. The ad information server is part of the chat ad system or is communicatively coupled therewith, according to an embodiment. In one embodiment, the ad request includes any of the following data for integration with a mobile ad information server (e.g., MoPub™, etc.):

Id: ad unit ID (required);

Version number: set to 1 (required);

Udid (required). This can be an ifa;

Ip (optional);

Q: comma-delimited keywords (optional);

Lat-long (optional);

Ct: connection type (optional);

Tp: set to ‘tango’ (required);

Mobile-web (optional); this will be required for ATM in the future; and

Dnt (optional).

Table 1, below, describes the immediately foregoing data.

| Parameter | Details | Purpose | Required |
|---|---|---|---|
| id | Ad unit ID | Indicates ad | Yes |
| | | placement | |
| v | version number (For | Indicates | Yes |
| | the purposes of this | version of | |
| | type of integration, | the API that | |
| | v = 1) | should be used | |
| udid | Device specific | Used for | Yes |
| | identifier, described | targeting by | |
| | below in further detail | DSPs and fre- | |
| | | quency capping | |
| | | features of | |
| | | the ad server. | |
| dnt | Do not track | Indicates if do | Yes, for |
| | indicator. | not track is | iOS 6+ |
| | (e.g. dnt = 1) | set up for | |
| | | this user. | |
| ip | IP Address (e.g. | Passes IP | Only if using |
| | “204.28.127.10”) | address | geo- |
| | | manually in the | targeting |
| | | parameter. | |
| q | comma-delimited | Sends up | No |
| | keywords | keywords that | |
| | | can be used for | |
| | | targeting. | |
| ll | lat-long coordinates | Passes up | If available |
| | (e.g. | location for | to the app |
| | “37.775, −122.418333”) | targeting by | for DSP |
| | | DSPs. | geotargeting |
| ct | connection type | Indicates | Only if using |
| | 0: Unknown, | connectivity | geo-targeting. |
| | 1: Ethernet, | type for | Pass up the |
| | 2: Wifi, | targeting. | corresponding |
| | 3: Cellular data - | Needed for | integer value, |
| | Unknown Generation, | connectivity | e.g. 5 for a |
| | 4: Cellular data - 2G, | targeting | 3G connection |
| | 5: Cellular data - 3G, | and IP based | |
| | 6: Cellular data - 4G) | geo-resolution. | |
| tp | third party indicator (e.g. | Indicates | Yes, for |
| | tp = yourcompanyname) | who is sending | third party |
| | | up the ad | S2S |
| | | request. | integrations. |
| mobile_web | mobile web indicator | Indicates if | No |
| | (e.g. if your ad call is | the request is | |
| | mobile web, set | mobile web. | |
| | mobile_web = 1) | | |

Additionally, in an embodiment, a chat ad is unique to a targeted device. For example, the chat ad may be created for any of, but not limited to, the following devices: Android™ phone; Android™ tablet; iPhone™ non-retina; iPhone™ retina; iPad™ non-retina; and iPad™ retina.

In one embodiment, the messaging application service provides a client-side 4× reduction to enable chat ad to only be used in retina assets. In one embodiment, the client performs this resizing. In another embodiment, the client performs the resizing if the CPU/GPU cost is reasonable.

In one embodiment, the chat ad that is requested will be time-stamped at the client by Unix time (t) or an otherwise client-authoritative time measurement. A new chat ad request shall be made when t+n minutes have elapsed. “n” will be set on the messaging application server (Tango™ messaging service) as a number of minutes, initially set to 60.

### Response to Chat Ad Requests

In one embodiment, two types of chat ads may be sent in response to the chat ad request described above: Type 1) A JSON string with 6 required elements and 3 optional elements; and 2) a JSON string with 4 required elements.

Type 1—JSON String with 6 Required Elements:

In one embodiment, a JSON string is sent to the messaging application service from the chat ad information server. The response includes, the following required elements and any of the optional elements:

a iconURL (required);

a heading (required);

an ad_text (optional);

an imageURL (required);

a clickURL (required);

a clickTrackURL (required);

an impTrackURL (required);

a star_rating (optional); and

a number_of_players (optional).

In the case of a chat ad that is a banner ad, the chat ad (that is a banner ad) is displayed as integrated in the chat list and/or in the social feed. The typical chat ad sizes for a banner ad are the following: smartphone—320×50 (non-retina iOS) or 640×100 (retina); and tablet—728×90.

Type 2—JSON String with 4 Required Elements:

In one embodiment, a JSON string is sent to the messaging application service from the chat ad information server. The JSON string may be, but is not limited to being, any of the following:

an imageURL (required);

a clickURL (required);

a clickTrackURL (required); and

an impTrackURL (required).

In one embodiment, a chat ad response contains all information to fully display the chat ad, account for impressions and clicks, and the destination URL (which can be the address of an application store (that makes available an application for purchase). In one embodiment, the click URL allows the messaging application to launch the requested application if a particular application (from, for example, the Google™ or Apple™ store) is installed, in the case of a software development kit (“SDK”) games.

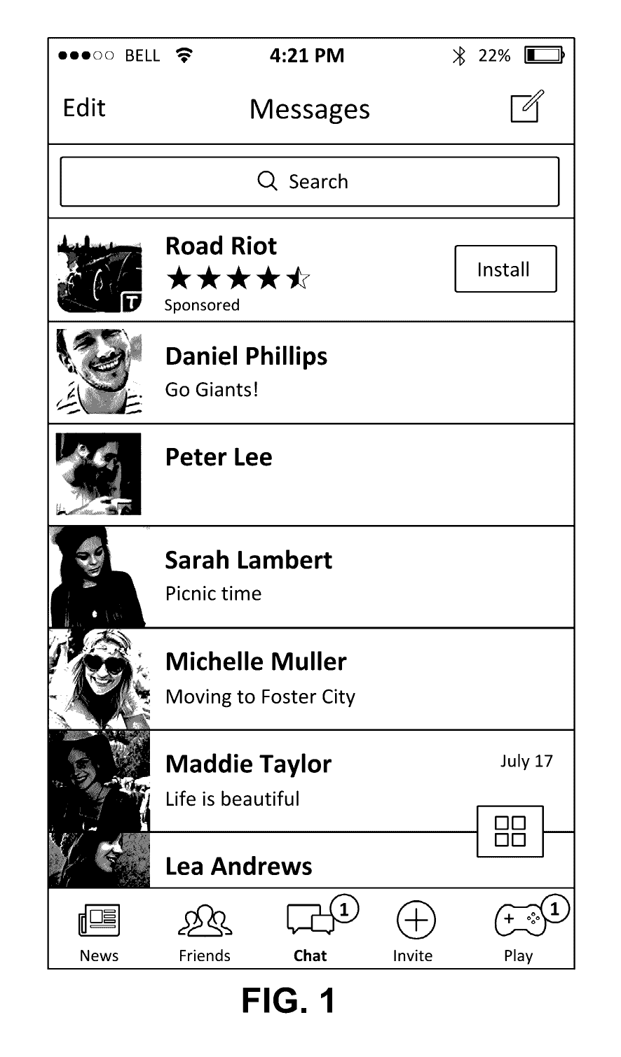

FIG. 1 illustrates an example of a response, including all information to fully display the ad, account for impressions, and clicks, in accordance with embodiments.

### Tracking Ad Impressions

In one embodiment, a chat ad counts as an impression if greater than a predetermined percentage of the image for the chat ad is displayed for longer than a predetermined period of time. For example, in one embodiment, an impression of a chat ad is counted if seventy five percent of the image for the chat ad is displayed for longer than one second. In one embodiment, when the one second elapses, an analytics HTTP request is made to count that impression with the data about that impression.

In one embodiment, the impressions for a chat ad are counted when the following happens: a user causes the chat ad to be in the foreground of the user's display on the user's mobile device, and the chat ad is visible according to the guideline regarding the parameters described regarding what percentage of display screen is taken up by the chat ad and/or for how long the chat ad is displayed; and a user navigates to a tab in the messaging application that has a chat ad and the chat ad is visible per the guideline regarding the parameters described regarding what percentage of the display screen is taken up by the chat ad and/or for how long the chat ad is displayed.

In one embodiment, the impressions for a chat ad are not counted when any of the following happens: a user scrolls up and down in a tab of the messaging application (this ensures that potential impressions are not over-counted); and when a phone goes to sleep when the chat ad is showing, and subsequently the user wakes it up and sees the chat ad again).

Next, chat ad impressions in a social feed, a chat list and a profile view will be discussed.

### Chat Ad Impressions in a Social Feed

In one embodiment, for each chat ad, a chat ad request is sent to the ad information server per the guideline provided above (“In one embodiment, the chat ad that is requested will be time-stamped on the client by Unix time (t) or an otherwise client-authoritative time measurement. A new chat ad request is made when t+n minutes have elapsed. “n” will be set on the messaging application servers as a number of minutes, initially set to 60).

In one embodiment, if no chat ad is sent back, then a previously rendered chat ad will be removed from the social feed. In one embodiment, if a chat ad is sent back, then a new chat ad shall be rendered. In one embodiment, the chat ad is not reflowed if the chat ad's creative is the same.

In one embodiment, the first chat ad will be shown above the fold in the social feed. It will be the second module from the top. This will ensure that user-generated content is shown to the user before the user looks at the chat ad. This makes sure that the social feed is a place of content, filled with user generated content (“UGC”) and supported by chat ads, not a list of ads.

For example, in one embodiment, four chat ad units are created for the social feed, separated by five to ten non-chat ad units. In one embodiment, a chat ad unit that cannot be separated from another chat ad unit by five to ten non-chat ad units is not requested.

In one embodiment, the chat ad, represented on the display screen, in its entirety, is selectable by a click and once selected, will lead to an opening of the application being advertised through the chat ad or will do a quick launch to an application store. The application store is an entity that may be accessed and at which an application may be purchased and downloaded or downloaded free of charge. In one embodiment, the application store is located at a messaging application service. In another embodiment, the application store is located at an ad information server.

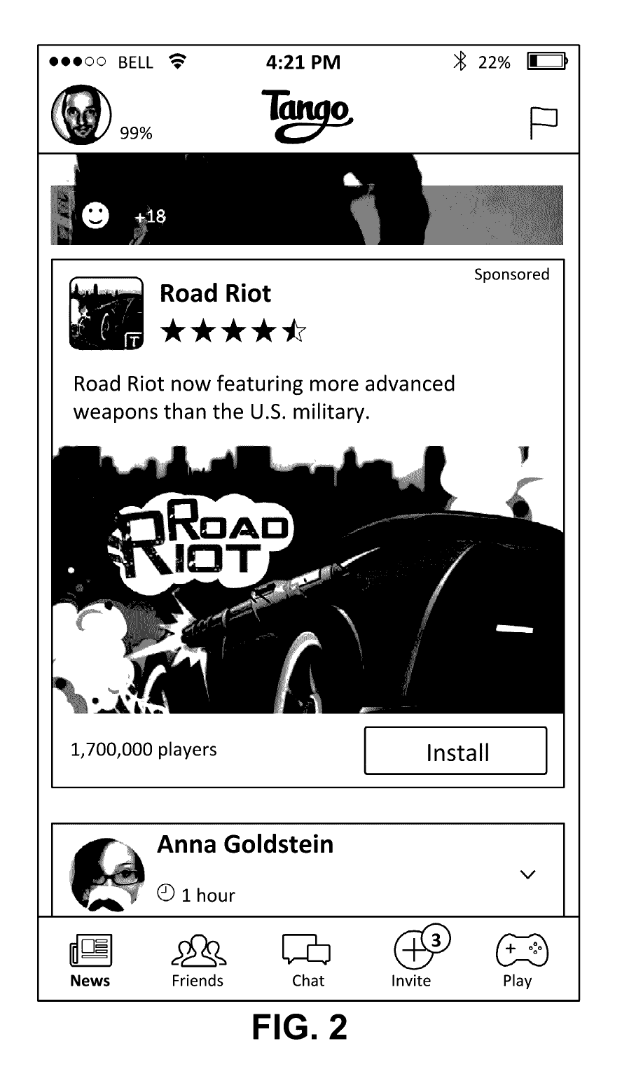

FIG. 2 illustrates an example of an ad impression in a social feed, in accordance with an embodiment.

### Chat Ad Impressions in Profile Views

In one embodiment, for each ad unit, an ad request is sent to the ad information server. In one embodiment, if no chat ad is sent back, then a previously rendered chat ad shall be removed. In one embodiment, if a chat ad is sent back, reflow is reduced if the chat ad is for the existing creative.

For example, in one embodiment, four chat ads are created for the profile page. These chat ads are inserted at different locations in the profile, but never at a first module, since the profile will always be a user-generated module (e.g., picture). For example, a chat ad may be inserted at a second, twelfth, twenty second and thirty two modules. The first module in the profile shall always be a user-generated module (e.g., picture). A chat ad that cannot be separated from another chat ad by a number of modules will not be requested.

In one embodiment, the chat ad in its entirety is selectable by a click and will lead to an opening of the application or will do a quick launch to the application store.

In one embodiment, a chat ad that is for a 3^{rd} party non-SDK shall be trackable through HasOffers™ and Kochava™.

In one embodiment, a performance requirement is considered. For example, so as to not impact servers too significantly as chat ads are fetched/pre-fetched, the number of chat ad requests made may be reduced depending on various factors. Restrictions may also be applied regarding providing the chat ad feature from the feed to the profile. For example, in one embodiment, no more than ten chat ads may be requested when a user is actively looking at a profile page; the restriction of ten chat ads or less has been applied to the messaging application.

In one embodiment, chat ads are refreshed in the profile page immediately. In one embodiment, when a user of the mobile device visits two different profiles, the user sees a different chat ad and a new impression shall be counted. In one embodiment, a user that goes to the same profile twice may see the same chat ad and that chat ad may be cached for up to an hour.

In one embodiment, the chat ads of the profile page shall be distinct from the chat ads in the news feed and operated separately. In another embodiment, a user that looks at their own profile shall never see chat ad in their own profile. In one embodiment, a chat ad is pre-fetched when the user indicates an intent for browsing profiles. In one embodiment, a chat ad request(s) is sent in response to the following non-limiting example events: when a user selects (e.g., by clicking, etc.) “Make Friends Nearby”; when a user selects (e.g., by clicking, etc.) “People you may know”; and when a user opens any profile page through any number of channels leading to a profile page.

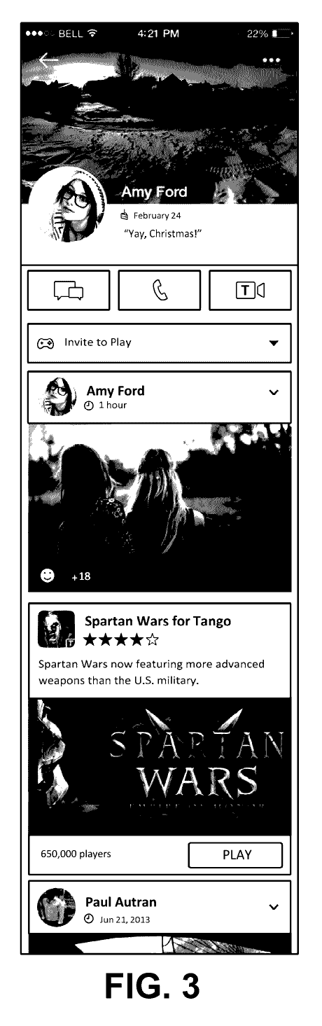

FIG. 3 illustrates an example of an ad impression in a profile view, in accordance with an embodiment.

### Ad Impressions in a Chat List

In one embodiment, for each chat ad, a chat ad request is sent to the ad information server. In one embodiment, if no chat ad is sent back, then a previously rendered chat ad is removed from the chat list. In one embodiment, if a chat ad is sent back, then a new chat ad is rendered. In one embodiment, chat ads are not reflowed in a chat list if the creative is the same.

In one embodiment, the first chat ad will always be shown in the first spot in the chat list and four chat ads are created for the chat list. Further chat ads are separated by five chat ads. This guarantees that a chat ad appears at the top of the chat list and a chat ad appears above the fold at the bottom of the chat list. A chat ad that cannot be separated from another chat ad unit by five chat ads may not be requested.

In one embodiment, the chat ad in its entirety is selectable (e.g., by clicking) and will lead to an opening of the application or will do a quick launch to the application store.

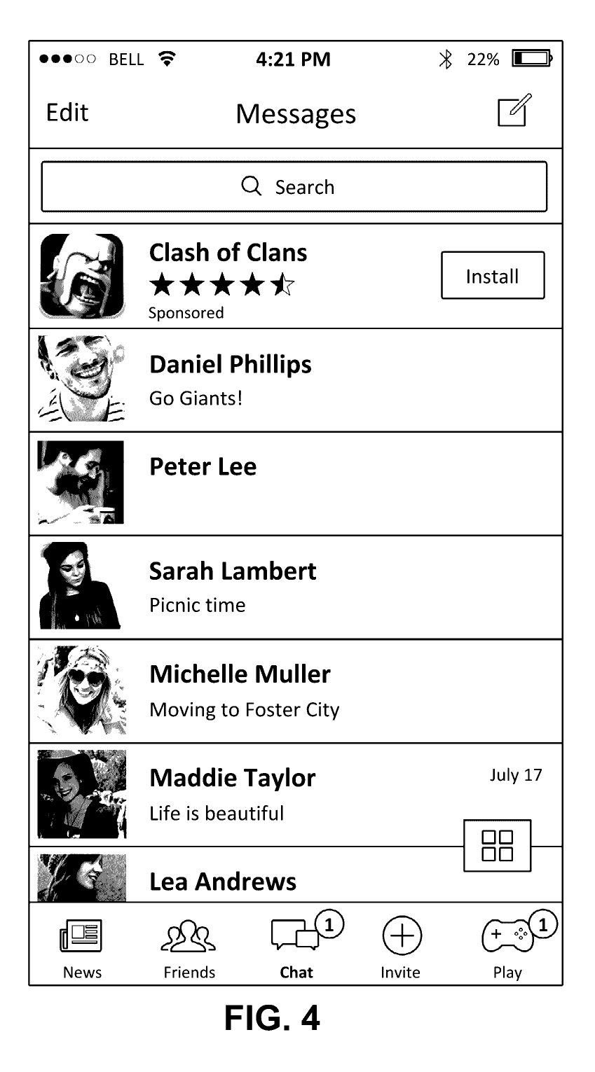

FIG. 4 illustrates an example of an ad impression in a chat list, in accordance with an embodiment.

### Ad Impressions in a Messaging Application Thread

In one embodiment, chat ads can also be displayed in a chat messaging list, wherein the chat ads were sent by a fan club or a messaging application service, or the insertion of a chat in a chat ad. In one embodiment, the chat messaging list is Tango Chat™ (“TC”).

In one embodiment, for each ad unit in the chat list, an ad request is sent to the ad information server. In one embodiment, if no ad campaign is running, then a previously rendered chat ad is removed from the chat list. In one embodiment, if an ad campaign is running, then a new chat ad will be rendered. In one embodiment, a chat ad will not be reflowed if the chat ad's creative is the same.

The chat ads may be positioned in any manner within the chat list. In one embodiment, four chat ads are created for a chat list, and the first chat ad will always be shown in the first spot in the chat list. Further, chat ads will be separated by five to ten chats within the chat list. A chat ad that cannot be separated from another chat ad by five to ten chats will not be requested.

In one embodiment, the chat ad in its entirety is selectable (e.g., via a click), and a selection leads to an opening of an application or a quick launch to an application store.

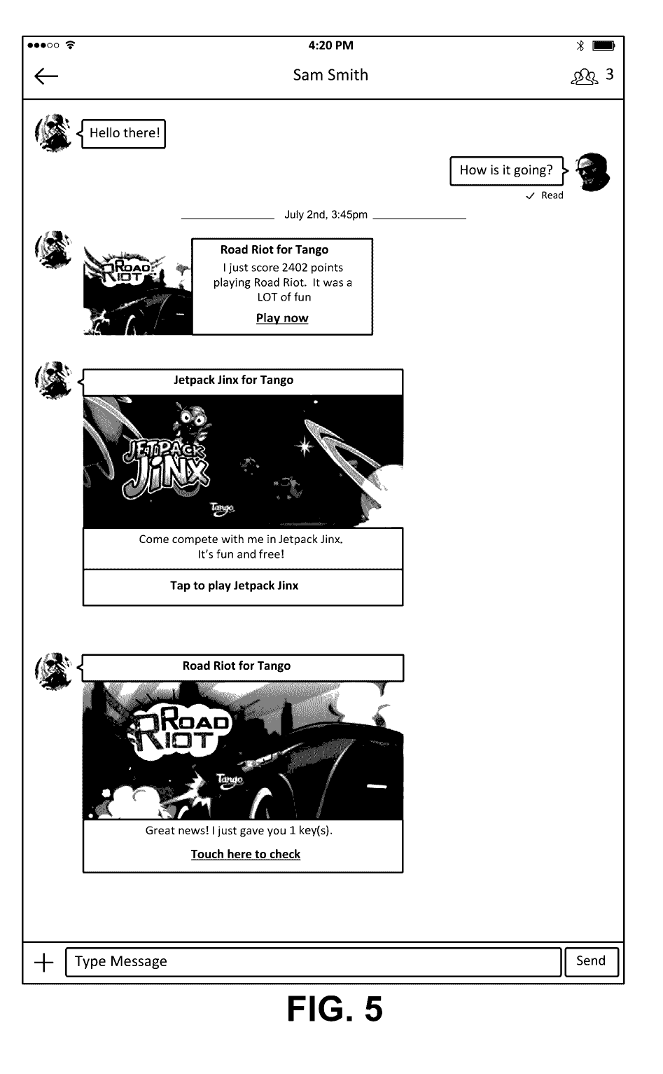

FIG. 5 illustrates an example of an ad impression in chat messaging list, in accordance with an embodiment.

### Tracking Chat Ad Impressions

Embodiments provide a method for tracking impressions regarding chat ads. Chat ads provide many interaction possibilities that can be analyzed as metrics. Embodiments are able to track these metrics.

Some Interaction possibilities include “click tracking” and “conversion tracking”.

In one embodiment, a click on a chat ad will generate two events: 1) a call to open a storekit to display the application in the application store (e.g., Quick Launch™); and 2) an HTTP call to clicktrackURL in order to count the click.

In another embodiment, an application that is opened, after being downloaded from the application store, is issued a call to an ad information server, such as any of the following: 1) Hasoffers™ attribution link; 2) Kochava™ attribution link; and 3) MoPub™ attribution link: a) Id: global application ID (iTunes™ id or Android™ package name); and b) Unique Device Identifier (“Udid”): Sha1 hashed identifier/ifa (whatever iOS allows).

In an embodiment, any of the following call to actions (CTAs) are possibly enabled through a chat ad: 1) play; 2) install; 3) open; 4) use application; 5) listen; 6) book; 7) shop; and 8) watch. In one embodiment, a string for “people who play this” and the foregoing CTAs are localized.

In one embodiment, the creative of a chat ad is allowed to be a video with a playback in feed capability.

In one embodiment, the following metrics are measured for the messaging application: Total impressions by the user; total clicks by the user; clickthrough rates of the user; and total installations performed by the user.

The total impressions by the user may be measured at any time (e.g., hourly, daily, weekly, monthly, etc.) The total impressions may be counted as to a social feed, a chat list, and a messaging application thread.

The total clicks by the user may be measured at any time (e.g., hourly, daily, weekly, monthly, etc.) The total clicks may be counted as to a social feed, a chat list, and a messaging application thread.

The clickthrough rate by the user may be measured at any time (e.g., hourly, daily, weekly, monthly, etc.) The clickthrough rate may be counted as to a social feed, a chat list, and a messaging application thread.

The total installations by the user may be measured. The total installations from the social feed, from the chat list, and from the messaging application thread, may be counted.

### Advertising Information Server

In one embodiment, the chat ad system includes the advertising information server. An advertising information server (“ad information server”) is a server that provides information regarding marketing campaigns that are running on the clients of the messaging application service. The ad information server is acting as an aggregator of campaign information that can be defined at different places. For example, some advertising campaigns can be created at the messaging application service or created using an ad information server.

This ad information server is initially invoked by client of the messaging application service to obtain information used by the store UserInterface (UI), the feed timeline UI or any other part of the application where a list of items (e.g., applications, ads, etc.) being promoted by the messaging application service need to be displayed to the user.

The following is a description of a list of steps that occur upon a client (of the messaging application service [“client”]) initially invoking the services of the ad information server.

STEP 1) The messaging application service client is also the client of the ad information server. The client issues a request to retrieve the list of available campaigns. The client can optionally specify the type of campaign to retrieve. The client will use the parameter “cid” with one of the following values: all; store; storebanner; profileapps; and feedads (See REST Interface below).

The REST Interface: Campaign Information for Specified Campaign Types

Each time the client requests a new campaign object from the ad information server, it constructs an HTTP GET request with the following GET parameters, shown in Table 2 below:

TABLE 2

| Parameter | Details | Purpose | Required | IM equivalent |
|---|---|---|---|---|
| cid | Comma separated | Indicates the type of | Yes | |
| | list of string. See | campaigns to retrieve. | | |
| | valid values below. | | | |
| cidnum | Comma separated | Indicates how many | Yes | |
| | list of string (number | items shall be returned | | |
| | or ‘all’). | for each requested cids | | |
| udid | SHA1 hashed | Passes up the unique | Yes | |
| | identifier, described | device identifier. | | |
| | below in further | | | |
| | detail | | | |
| devicetype | String identifying the | Passes up the device | Yes | |
| | device type (“ios” or | type. Should be added | | |
| | “android”) | to the User-Agent | | |
| | | header field | | |
| devicemodel | String identifying the | Passes up the device | Yes | |
| | device model | model. Should be | | |
| | (“Galaxy Nexus”) | added to the User- | | |
| | | Agent header field | | |
| osver | Version of os | OS version. Should be | Yes | |
| | | added to User-Agent | | |
| | | header field of the | | |
| | | server request | | |
| dpi | Dpi of the device: | Should be mapped into | No | |
| | android - xhdpi | a custom keyword | | |
| | ios: xhdpi | passed to ad | | |
| | | information server. | | |
| | | Keyword name should | | |
| | | be devdpi | | |
| q | comma-delimited | Sends up keywords | No | |
| | keywords | that can be used | | |
| | | for targeting | | |
| ll | lat-long coordinates | Passes location for | No | device.geo.lat and |
| | (e.g. | targeting | | device.geo.lon |
| | “37.775, −112.418333”) | | | |
| ct | Connection type: | Needed for | No | device.connectiontype |
| | 0: Unknown | connectivity targeting | | |
| | 1: Ethernet | and IP based geo- | | |
| | 2: Wi-Fi | resolution | | |
| | 3: Cellular | | | |

‘cid’ Parameter: shown in Table 3 below.

TABLE 3

| | | Allowed Item |
|---|---|---|
| | | Types in |
| cid | Description | campaign response |
| all | Retrieves all the campaigns from | n/a |
| | AdInfo | |
| store | Retrieves the campaign (SDK and | game, app |
| | non-SDK games for now) to display | |
| | in the store list. | |
| storebanner | Retrieves the campaign to display | game, app |
| | in the store banner. | |
| profilegames | Retrieves the campaign to display | game, app |
| | in the game invite section of each | |
| | profile page. | |
| feed | Retrieves the campaign to display | ad |
| | in the feed timeline. The campaign | |
| | returned is limited for now to a list | |
| | of ad items. | |

‘udid’ parameter:

iOS:

AN requests to ad information server include a hashed user identifier as one of the GET parameters. On iOS, the identifier used is the IDFA (identifier for advertising). The ‘udid’ field is used to pass the device identifier in the following format: “ifa:6642350D5CBA413F95ECCDD69C427C2D”.

Android:

For Android, use Secure.ANDROID_ID. Before sending this identifier to the ad information server, the SHA1 hash of the uppercased identifier and the prefix for this hash with the string “sha:” is generated.

As an example, the identifier “FC5C225A89A3ABA67A58A49B6020AA07” should become “sha:CF95DB7F559BD1FC1ACC842135E2CA536C14F8AE”.

Example of an API Request:

The following is a non-limiting example, and numbers in the fields described below are non-authoritative.

10.19.25.113—[23/Nov/2013:07:02:09+0000] “GET/adinfo/v1/?cid=feed&cidnum=all&udid=sha%3Ac068796e008265665bdb0d9d6c4b0d4 6a8db54ff&devicetype=android&devicemodel=DROID%20RAZR_XT912_verizon&osve r=4.1.2&dpi=xhdpi&ll=37.3169%2C-122.002&dnt=0 HTTP/1.1” 200 7543

STEP 2) The messaging application service sends back the response to the client if it is already in its cache. Otherwise, the messaging application service will hit the origin server—the ad information server.

JSON Response Format: The response from the ad information server includes at least the following three types of elements:

1. A list of items. An item can be anything (e.g., a partner game, a game install, an application, an ad, etc.). An item is identified in this list by a unique identifier ‘uid’.

Campaign Item Description: Below, in Table 4, is a list of fields, mandatory and optional, that are embedded in each item:

TABLE 4

| | | | | Optional/ |
|---|---|---|---|---|
| Name | Type | Description | Value | Mandatory |
| title | string | The item title | 30 | M |
| | | | character | |
| | | | max | |
| subtitle | string | The item description | 100 | M |
| | | | character | |
| | | | max | |
| app_url | string | The URL scheme to launch the app | | O |
| | | on the device | | |
| click_url | string | The URL to open when click | See below | M |
| | | action happened if the app is | | |
| | | not installed on the device. | | |
| | | This will generally be a link to a | | |
| | | tracking system (HasOffer, | | |
| | | Kochava) that will redirect | | |
| | | to the appstore/playstore | | |
| | | This URL can contain some | | |
| | | template fields that are meant | | |
| | | to be filled by TangoClient: | | |
| | | $IOS_IFA: Apples iOS 6+ | | |
| | | Advertiser Identifier user's device | | |
| | | $IOS_IFA_SHA1 Apples iOS 6+ | | |
| | | Advertiser Identifier user's device | | |
| | | encrypted using SHA-1 | | |
| | | $MAC_ADDR: Mac Address of | | |
| | | the device | | |
| | | $MAC_ADDR_SHA1: Mac | | |
| | | Address of the device encrypted | | |
| | | using SHA-1 | | |
| | | $ANDROID_ID: Android ID of the | | |
| | | user's device | | |
| | | $ANDROID_DEVICE_ID: Android | | |
| | | IMEI/MEID of the user's device | | |
| | | $ANDROID_DEVICE_ID_SHA1: | | |
| | | Android IMEI/MEID of the user's | | |
| | | device ecnrypted using SHA-1 | | |
| | | $ANDROID_ADID: Google's new | | |
| | | ID for advertisers | | |
| | | $TANGO_CHANNEL: Tango | | |
| | | channel form where track request has | | |
| | | been issued (e.g. store, storebanner, | | |
| | | feedad . . .) | | |
| click_track | Array<string> | An array of tracking URLs to open | | O |
| | | when click action happened. | | |
| | | This track URL can contain the same | | |
| | | template fields as for the click_track | | |
| | | URLs. | | |
| imp_track | Array<string> | An array of URLs to open when | | O |
| | | impression happened. | | |
| | | This track URL can contain the same | | |
| | | template fields as for the click_track | | |
| | | URLs. | | |
| icon_xhdpi | Nested json | URL for the location of the app icon | | M |
| | object | for different screen density | | |
| image_xhdpi | Nested json | URL for the location of the image ad | | M for |
| | object | for different screen density | | feed/profile |
| star_rating | float | The number of stars in current store | | O |
| | | (AppStore or PlayStore) | | |
| players_num | int | Number of players | | O |
| show_if_installed | Boolean | If set to true, then the ad will be | | true |
| | | hidden if the app (defined by | | |
| | | app_url) is already installed on the | | |
| | | client. Otherwise the client will show | | |
| | | the ad regardless. | | |
| cta_install | String | A list of call to action labels. If one | | |
| | | of the following strings are used, then | | |
| | | they will be localized automatically: | | |
| | | Install | | |
| | | Open | | |
| | | Use App | | |
| | | Play | | |
| | | Listen | | |
| | | Book | | |
| | | Shop | | |
| | | Watch | | |
| | | Otherwise, the string will be | | |
| | | displayed as is. Note that the strings | | |
| | | are case sensitive. | | |
| | | Different call-to-action string can be | | |
| | | specified for install (if an app | | |
| | | specified by app_url is not installed) | | |
| | | and open | | |

The following is an example successful JSON response:

```
{
    “app_url”: “com.angryheroesgame.tango”,
    “cta_install”: “install”,
    “cta_open”: “Play”,
    “click_url”:“https://play.google.com/store/apps/details?id=
com.angryheroesgame.tango”,
    “icon_xhdpi”: {
          “w”: “100”,
          “h”: “100”,
          “url”:
“http://d30x8mtr3hjnzo.cloudfront.net/creatives/505fdea71c16416a
b9fd9a091c3f8db2”
      },
      “image_xhdpi”: {
          “w”: “640”,
          “h”: “334”,
          “url”:
“http://d30x8mtr3hjnzo.cloudfront.net/creatives/7cc4382d4c7f4920
a4493563e804d719”
      },
    “players_num”:“500000”,
    “star_rating”:“4.4”,
    “subtitle”:“A fascinating MMORPG with stunning comic-style
art and a lot of humor”,
    “title”:“Angry Heroes”,
    “uid”:“1379087581912”
}
```

2. A list of ad spaces corresponding to the set of placeholders within the messaging application service where an item can be rendered. Each ad space contains a dictionary of integers, each integer corresponds to the item position in ‘items’ array.

3. A status (OK or an error message) is provided.

STEP 3) The ad information server will retrieve the campaign data and format the response to send to client in the right format (see REST Interface below). The ad information server may optionally need to send a query to ad network providers. (See STEP 4.)

STEP 4) If the request type is “all” or “feedads”, the ad information server will submit a request to the ad information server to retrieve the list of ad items in a partner format (e.g., JSON). The ad information server will convert the response to the client campaign format.

STEP 5) A response is sent back to the client.

STEP 6) After parsing the response, the client could get assets from either the messaging application service (including a content delivery network [“CDN”]) or a third-party CDN.

STEP 7) An action occurs if the user clicks on an item that includes redirecting to an Apple Appstore™ or Android Play Store™, opening tracking URL, etc.

### Implementing the Chat Ads on a Device

Several sets of sizes of chat ads are defined in the following sections. The “minimal set” works for all mobile devices. Chat ads are optimized for retina/xhdpi phones.

All sets do not have to be provided. A minimal set is enough. Only if it is desired to optimize for sub retina dpi phones or have a special set of creatives for tablets, will an additional set(s) needs to be provided.

The Retina tablet and iPad set is a high definition set that will provide superior quality on retina ipads and tablets. For simplicity, only xhdpi is required for all devices.

| | Banner | |
|---|---|---|
| Set name | (Face book style) | Icon |
| Minimal set (xhdpi) | 640 × 334 pixel | 100 × 100 pixel |
| Retina tablets and iPad | 1200 × 627 pixel | 100 × 100 pixel |
| **(xhdpi) | | |

Thus, embodiments provide a method and system for driving application installations and driving engagement with advertisers and between users and advertisers. Embodiments provide for the cross-promotion for partner games and for the direct sale of ads for games.

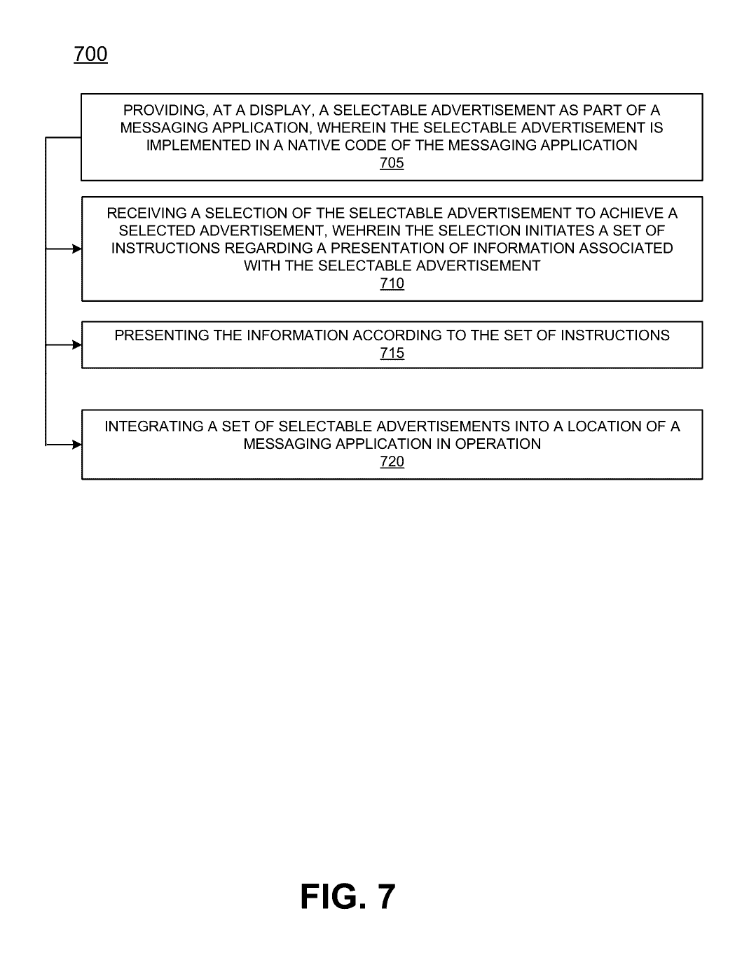

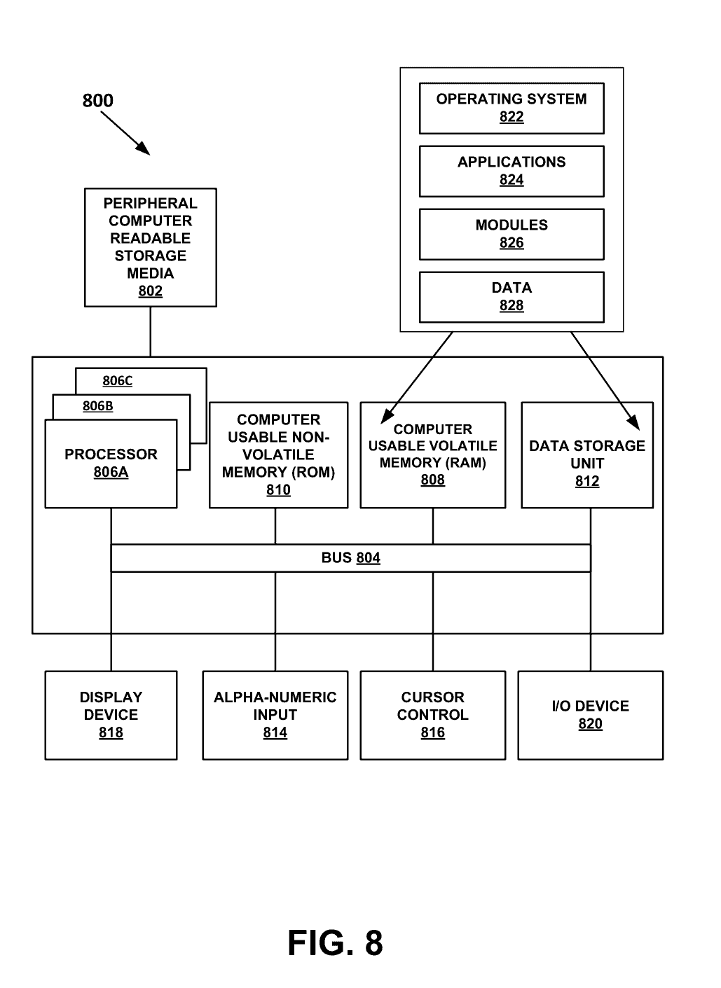

The following discussion will begin with a description of an advertisement presenter and a chat advertisement system, with reference to FIG. 6. The discussion will follow with a description of a method of operation for presenting an advertisement within a display of information provided by a messaging application, with reference to FIG. 7. With reference to FIG. 8, the discussion concludes with a description of an example computer system with which or upon which various embodiments of the present technology may be implemented.

### Example Advertisement Presenter

FIG. 6 depicts a block diagram that illustrates an advertisement presenter 600 that includes the following modules coupled with a computer, such as computer 800 of FIG. 8: an selectable advertisement provider 605; a selection receiver 615; and a selectable advertisement integrater 625. The selectable advertisement provider 605 optionally includes a selectable advertisement presenter 610. In one embodiment, the advertisement presenter 600 resides at the messaging application service 630, while in another embodiment, the advertisement presenter 600 resides at a mobile phone 660 of a user 655. The messaging application service 530 is communicatively coupled with (via wire and/or wirelessly) the advertisement (ad) server 640, the ad campaign manager 645 and the mobile phone 660. FIG. 6 also shows a chat advertisement (chat ad) system 635 that includes the ad information server 640, the messaging application service 630, and the ad campaign manager 645. FIG. 6 further shows that the business 650 is communicatively coupled with any of the following: the ad information server 640; the messaging application service 630; and the ad campaign manager 645. Of note, at least one of the modules of the chat ad system 635 is communicatively coupled with the mobile phone 660.

Also shown in FIG. 6 and located at the messaging application service 630 are the following components: a receiver 672; a processor 674; a display screen 680; a transmitter 676; and a memory device 678. In one embodiment, the memory device 678 is part of the advertisement presenter 600. In another embodiment, the memory device 678 is remote from, but communicatively coupled with, the advertisement presenter 600. In one embodiment, the advertisement presenter 600 resides at a messaging application service 630. In another embodiment, the advertisement presenter 600 is remote from, but coupled communicatively (via wire and/or wirelessly) the messaging application service 630. In one embodiment, the memory device 678 is located at a server remote from the messaging application service 630.

The advertisement presenter 600 will now be discussed, with reference to FIG. 6. The advertisement presenter 600 includes: the selectable advertisement provider 605; the selection receiver 615; the information presenter 620; and the selectable advertisement integrater 625.

The selectable advertisement provider 605 is configured for providing, at a display screen (of a mobile device), a selectable advertisement as part of a messaging application, wherein the selectable advertisement is implemented in a native code of the messaging application. For example, the selectable advertisement provider 605 provides, at the display screen 670 of the mobile device, such as mobile phone 660, and via the messaging application 665 downloaded onto the mobile phone 660 a selectable advertisement. The selectable advertisement is implemented in a native code of the messaging application 665. By selectable advertisement, for example, it is meant to include ads which are presented at the display screen 670, which may be selected by the user 655 via any method known in the art for selecting content from a mobile device (e.g., clicking, voice activated, pushing a button on the mobile device, etc.).

In one embodiment, the selectable advertisement provider 605 includes a selectable advertisement presenter 610. The selectable advertisement presenter 610 is coupled with a computer, such as the computer 800 of FIG. 8, and is configured for presenting the selectable advertisement at the display (e.g., such as the display screen 670) such that the selectable advertisement moves in unison with the content of the messaging application that is being displayed at the display screen 670. In other words, the selectable advertisement follow the same pattern of movement as the content that is being displayed on the display screen, in one embodiment.

The selection receiver 615 is configured for receiving a selection of the selectable advertisement to achieve a selected advertisement. The selection initiates an execution of a set of instructions regarding a presentation of information associated with the selectable advertisement. For example, the user 655 selects one of the selectable advertisements displayed at the display screen 670. The selection receiver 615 then receives this selection. Once the message has been sent that a particular ad has been selected by the user 655, and this message is received at the advertisement presenter 600, an initiation of an execution of a set of instructions associated with said selection of the advertisement is performed. For example, if the user 655 clicks on a particular advertisement advertising a gaming application, the set of instructions may include sending more information about this gaming application, as well as the opportunity to download the gaming application, to the user 655. Another set of instructions may include sending to the user 655 information about co-branded gaming application, such that the user 655 may be made aware of other gaming applications generally played alongside this particular gaming application. Of note, the set of instructions may include any content that results in a presentation of information associated with the selected advertisement. In one embodiment, the set of instructions includes installing an application, wherein the presentation of information includes the application, and wherein the application is the subject of the selected advertisement. In another embodiment, the set of instructions includes displaying the application data regarding the application, wherein the presentation of information includes the application data, and wherein the application data includes a description of the application, wherein the application is the subject of the selected advertisement.

The information presenter 620 is configured for presenting the information according to the set of instructions. For example, the information presenter 620 may present a description of a gaming application, along with a download capability, to the user 655. In another embodiment, the information presenter 620 may present only the possibility to download the application that was advertised and was selected by the user 655. In one embodiment, for example, the selectable ad(s) are presented at the display screen 670 of the mobile phone 660, such that it moves in unison with the content of the messaging application 665 that is being displayed at the display screen 670 of the mobile phone 660. In one embodiment, the selectable content of the messaging application moves as part of a horizontal scroll. In another embodiment, the selectable content of the messaging application moves as part of a vertical scroll.

The advertisement unit displayer 410 displays at least one advertisement unit of the advertisement units in response to a display instruction. The display instruction is a request communicated to the advertisement carousel system 400 for a particular advertisement unit to be presented to the user in a particular font and format. This font and format may be that font and format that is established as a factory, default setting, in one embodiment. In another embodiment, the font and format may be a font and format that is established by the user. In one embodiment, the advertisement unit displayer 410 optionally includes: a horizontal advertisement unit displayer 420 configured for displaying, via the advertisement carousel, the at least one advertisement unit such that the advertisement carousel may be browed horizontally; and a vertical advertisement unit displayer 425 configured for displaying, via the advertisement carousel, the at least one advertisement unit such that the advertisement carousel may be browed vertically.

In one embodiment, the selectable advertisement integrater 625 integrates a set of selectable advertisements into a location of a messaging application in operation. In one embodiment, the location at which the selectable advertisements are integrated is a social feed. In another embodiment, the location at which the selectable advertisements are integrated is a chat list. In yet another embodiment, the location at which the selectable advertisements are integrated is a profile page of the user.

In one embodiment, the advertisement carousel is cyclic. In another embodiment, each advertisement unit of the advertisement units is the same size. In one embodiment, the advertising networks are responsible for sizing their advertisements according to the size at which the advertisement unit will be displayed. In one embodiment, the advertisement carousel occurs in a feed mode. In another embodiment, the advertisement carousel occurs in a profile mode.

In one embodiment, a chat advertisement system 635 includes the following components, communicatively coupled with a computer, such as the computer 800 of FIG. 8: the advertisement presenter 600 that includes the selectable advertisement provider 605, the selection receiver 615 and the information presenter 620; the advertising information server 640; and the advertisement campaign manager 645. The selectable advertisement provider 605 optionally includes a selectable advertisement presenter 610, in one embodiment. Additionally, the ad information server 640, the ad campaign manager 645 and the advertisement presenter 600 may each include its own receiver, processor, display screen, transmitter and memory device for performing a portion of the methods and systems described herein.

The ad information server 640 is communicatively coupled with the messaging application service 630 and a computer, such as the computer 800 of FIG. 8. The ad information server 640 is configured for creating an advertisement in native code of the messaging application. The advertisement campaign manager 645 is communicatively coupled with the messaging application service 630 and a computer, such as the computer 800 of FIG. 8. The advertisement campaign manager 645 is configured for managing an advertisement campaign for a set of clients (i.e., one or more clients). The advertisement campaign may be any set of instructions, requests, completed work and/or work to be completed and associated with advertisements for a client.

An input device, such as the I/O device 820 of FIG. 8, described herein below, is configured for receiving a selection of a selectable advertisement.

The processor 674 is configured for executing the methods described herein at least with regard to the advertisement presenter 600. The processor 674 may be implemented, for example, by one or more discrete modules (or data processing components) that are not limited to any particular hardware, firmware, or software (i.e., machine readable instructions) configuration. The processor 674 may be implemented in any computing or data processing environment, including in digital electronic circuitry, e.g., an application-specific integrated circuit, such as a digital signal processor (DSP) or in computer hardware, firmware, device driver, or software (i.e., machine readable instructions). In some implementations, the functionalities of the modules are combined into a single data processing component. In other versions, the respective functionalities of each of one or more of the modules are performed by a respective set of multiple data processing components.

The processor 674 is configured for, at least, performing the following processing steps: providing, at a display, a selectable advertisement as part of a messaging application, wherein the selectable advertisement is implemented in a native code of the messaging application; receiving a selection of the selectable advertisement to achieve a selected advertisement, wherein the selection initiates an execution of a set of instructions regarding a presentation of information associated with the selected advertisement; and presenting the information according to the set of instructions. In one embodiment, the processor 674 is further configured for integrating a set of selectable advertisements into a location of a messaging application in operation.

The memory device 678 stores process instructions (e.g., machine-readable code, such as computer software) for implementing methods executed by processor 674, as well as data that processor 674 generates or processes, as is discussed herein. The memory device 678 may include one or more tangible machine-readable storage media. Memory devices suitable for embodying these instructions and data include all forms of computer-readable memory, including, for example, semiconductor memory devices, such as EPROM, EEPROM, and flash memory devices, magnetic disks such as internal hard disks and removable hard disks, magneto-optical disks, and ROM/RAM devices.

The receiver 672 is configured for, at least, receiving a selection of the selectable advertisement.

### Example Methods of Operation

The following discussion sets forth in detail some example methods of operation of embodiments. With reference to FIGS. 1-7, a flow diagram of method 700 for enabling presenting an advertisement within a display of information provided by a messaging application is shown, in accordance with embodiments. Method 700 includes some procedures that, in various embodiments, are carried out by a processor under the control of computer-readable and computer-executable instructions. In various embodiments, these computer-readable and computer-executable instructions are described as “code segments”, and presented separately (e.g., first codes segment, second code segment, etc.) to describe such instructions. In this fashion, procedures described herein and in conjunction with these flow diagrams, alone or in combination, are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, and optical disks, solid-state disks, any or all of which may be employed within a virtualization infrastructure. The computer-readable and computer-executable instructions, which reside on tangible computer readable storage media, are used to control or operate in conjunction with, for example, one or some combination of processors of a virtual machine. It is appreciated that the processor(s) may be physical or virtual or some combination (it should also be appreciated that a virtual processor is implemented on physical hardware).

The following discussion of method 700 references FIGS. 1-7 unless specifically noted otherwise.

At step 705 of method 700, in one embodiment and as described herein, a selectable advertisement is provided at a display as part of a messaging application, wherein the selectable advertisement is implemented in a native code of the messaging application.

At step 710 of method 700, in one embodiment and as described herein, a selection of the selectable advertisement is received, thus achieving a selected advertisement. The selection initiates an execution of a set of instructions regarding a presentation of information associated with the selected advertisement.

At step 715 of method 700, in one embodiment and as described herein, the information is presented according to the set of instructions.

At step 720 of method 700, in one embodiment and as described herein, a set of selectable advertisements is integrated into a location of a messaging application in operation.

### Example Computer System

With reference now to FIG. 8, all or portions of some embodiments described herein are composed of computer-readable and computer-executable instructions that reside, for example, in computer-usable/computer-readable storage media of a computer system. That is, FIG. 8 illustrates one example of a type of computer (computer system 800) that can be used in accordance with or to implement various embodiments which are discussed herein. It is appreciated that computer system 800 of FIG. 8 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, distributed computer systems, media centers, handheld computer systems, multi-media devices, and the like. Computer system 800 of FIG. 8 is well adapted to having peripheral non-transitory computer-readable storage media 802 such as, for example, a floppy disk, a compact disc, digital versatile disc, other disc based storage, universal serial bus “thumb” drive, removable memory card, and the like coupled thereto.

System 800 of FIG. 8 includes an address/data bus 804 for communicating information, and a processor 806A coupled with bus 804 for processing information and instructions. As depicted in FIG. 8, system 800 is also well suited to a multi-processor environment in which a plurality of processors 806A, 806B, and 806C are present. Conversely, system 800 is also well suited to having a single processor such as, for example, processor 806A. Processors 806A, 806B, and 806C may be any of various types of microprocessors, and may be the processor 802 described with respect to FIGS. 6 and 7. System 800 also includes data storage features such as a computer usable volatile memory 808, e.g., random access memory (RAM), coupled with bus 804 for storing information and instructions for processors 806A, 806B, and 806C.

System 800 also includes computer usable non-volatile memory 810, e.g., read only memory (ROM), coupled with bus 804 for storing static information and instructions for processors 806A, 806B, and 806C. In one embodiment, the memory device 880 of FIG. 6 is an example the computer usable volatile memory 808 and/or the computer usable non-volatile memory 810. Also present in system 800 is a data storage unit 812 (e.g., a magnetic or optical disk and disk drive) coupled with bus 804 for storing information and instructions. System 800 also includes an optional alphanumeric input device 814 including alphanumeric and function keys coupled with bus 804 for communicating information and command selections to processor 806A or processors 806A, 806B, and 806C. System 800 also includes an optional cursor control device 816 coupled with bus 804 for communicating user input information and command selections to processor 806A or processors 806A, 806B, and 806C. In one embodiment, system 800 also includes an optional display device 818 coupled with bus 804 for displaying information.

Referring still to FIG. 8, optional display device 818 of FIG. 8 may be a liquid crystal device, cathode ray tube, plasma display device or other display device suitable for creating graphic images and alphanumeric characters recognizable to a user. Optional cursor control device 816 allows the computer user to dynamically signal the movement of a visible symbol (cursor) on a display screen of display device 818 and indicate user selections of selectable items displayed on display device 818. Many implementations of cursor control device 816 are known in the art including a trackball, mouse, touch pad, joystick or special keys on alphanumeric input device 814 capable of signaling movement of a given direction or manner of displacement. Alternatively, it will be appreciated that a cursor can be directed and/or activated via input from alphanumeric input device 814 using special keys and key sequence commands. System 800 is also well suited to having a cursor directed by other means such as, for example, voice commands. System 800 also includes an I/O device 820 for coupling system 800 with external entities. For example, in one embodiment, I/O device 820 is a modem for enabling wired or wireless communications between system 800 and an external network such as, but not limited to, the Internet.

Referring still to FIG. 8, various other components are depicted for system 800. Specifically, when present, an operating system 822, applications 824, modules 826, and data 828 are shown as typically residing in one or some combination of computer usable volatile memory 808 (e.g., RAM), computer usable non-volatile memory 810 (e.g., ROM), and data storage unit 812. In some embodiments, all or portions of various embodiments described herein are stored, for example, as an application 824 and/or module 826 in memory locations within RAM 808, computer-readable storage media within data storage unit 812, peripheral computer-readable storage media 802, and/or other tangible computer-readable storage media.

What we claim is:

1. An article of manufacture, which comprises a computer readable medium having stored therein a computer program for presenting an advertisement within a display of information provided by a messaging application, said computer program comprising:
a first code segment which, when executed on a computer, provides, at a display, a selectable advertisement as part of a messaging application, wherein said selectable advertisement is implemented in a native code of said messaging application;
a second code segment which, when executed on said computer, receives a selection of said selectable advertisement to achieve a selected advertisement, wherein said selection initiates an execution of a set of instructions regarding a presentation of information associated with said selected advertisement; and
a third code segment which, when executed on said computer, presents said information according to said set of instructions.

2. The article of manufacture of claim 1, wherein said set of instructions comprises:
installing an application, wherein said presentation of information comprises said application, and wherein said application is the subject of said selected advertisement.

3. The article of manufacture of claim 1, wherein said set of instructions comprises:
displaying application data regarding an application, wherein said presentation of information comprises said application data, and wherein said application data comprises a description of said application, wherein said application is the subject of said selected advertisement.

4. The article of manufacture of claim 1, further comprising:
a fourth code segment which, when executed on said computer, integrates a set of selectable advertisements into a location of a messaging application in operation.

5. The article of manufacture of claim 4, wherein said location comprises:
a social feed.

6. The article of manufacture of claim 4, wherein said location comprises:
a chat list.

7. The article of manufacture of claim 1, wherein said location comprises:
a profile page.

8. The article of manufacture of claim 1, wherein said first code segment comprises:
a fifth code segment which, when executed on said computer, presents said selectable advertisement at said display such that it moves in unison with content of said messaging application that is being displayed at said display screen.

9. The article of manufacture of claim 8, wherein said selectable content of said messaging application moves as part of a horizontal scroll.

10. The article of manufacture of claim 8, wherein said selectable content of said messaging application moves as part of a vertical scroll.

11. An advertisement presenter comprising:
a selectable advertisement provider coupled with a computer, said selectable advertisement provider configured for providing, at a display screen, a selectable advertisement as part of a messaging application, wherein said selectable advertisement is implemented in a native code of said messaging application;
a selection receiver coupled with said computer, said selection receiver configured for receiving a selection of said selectable advertisement to achieve a selected advertisement, wherein said selection initiates an execution of a set of instructions regarding a presentation of information associated with said selected advertisement; and
an information presenter coupled with said computer, said information presenter configured for presenting said information according to said set of instructions.

12. The advertisement presenter of claim 11, further comprising:
a selectable advertisement integrater coupled with said computer, said selectable advertisement integrater configured for integrating a set of selectable advertisements into a location of a messaging application in operation.

13. The advertisement presenter of claim 12, wherein said location comprises:
a social feed.

14. The advertisement presenter of claim 12, wherein said location comprises:
a chat list.

15. The advertisement presenter of claim 12, wherein said location comprises:
a profile page.

16. The advertisement presenter of claim 11, further comprising:
a selectable advertisement presenter coupled with said computer, said selectable advertisement presenter configured for presenting said selectable advertisement at said display screen such that said selectable advertisement moves in unison with content of said messaging application that is being displayed at said display screen.

17. The advertisement present of claim 16, wherein said selectable content of said messaging application moves as part of one of a horizontal scroll and a vertical scroll.

18. The advertisement presenter of claim 11, wherein said set of instructions comprises:
installing an application, wherein said presentation of information comprises said application, and wherein said application is the subject of said selected advertisement.

19. The advertisement presenter of claim 11, wherein said set of instructions comprises:
displaying application data regarding an application, wherein said presentation of information comprises said application data, and wherein said application data comprises a description of said application, wherein said application is the subject of said selected advertisement.

20. A chat advertisement system comprising:
a messaging application service comprising:
an advertisement presenter comprising:
a selectable advertisement provider coupled with a computer, said selectable advertisement provider configured for providing, at a display screen, a selectable advertisement as part of a messaging application, wherein said selectable advertisement is implemented in a native code of said messaging application;
a selection receiver coupled with said computer, said selection receiver configured for receiving a selection of said selectable advertisement to achieve a selected advertisement, wherein said selection initiates an execution of a set of instructions regarding a presentation of information associated with said selected advertisement;
an information presenter coupled with said computer, said information presenter configured for presenting said information according to said set of instructions;
an advertising information server communicatively coupled with said messaging application service, said advertising information server configured for creating an advertisement in said native code of said messaging application; and
an advertisement campaign manager communicatively coupled with said messaging application service and said advertising information server, said advertisement campaign manager configured for managing an advertisement campaign for a set of clients.
